(19) United States
(12) Patent Application Publication
(10) Pub. No.: US 2023/0211942 A1
(43) Pub. Date: Jul. 6, 2023

(54) WEATHER RESISTANT PLASTIC PACKAGING

(71) Applicant: RMX Industries, Jalandhar (IN)

(72) Inventors: Kulvinder Rastogi, Jalandhar (IN); Abhinav Rastogi, Jalandhar (IN)

(21) Appl. No.: 18/090,046

(22) Filed: Dec. 28, 2022

Related U.S. Application Data
(60) Provisional application No. 63/295,157, filed on Dec. 30, 2021.

(51) Int. Cl. B65D 85/04; B65D 63/10; B41J 11/00; B31B 50/20; B65B 5/04; B65D 73/00

(52) U.S. Cl. CPC B65D 85/04; B65D 63/1081; B41J 11/00214; B31B 50/20; B65B 5/04; B65D 73/0014; B65D 2203/02; B31B 2110/40

(57) ABSTRACT

A method of packaging an outdoor product includes providing an outdoor product, and providing a sheet of polyvinyl chloride (“PVC”). The method also includes printing indicia on the sheet of PVC using a UV printing process, cutting the sheet of PVC to a desired shape, and affixing the sheet of PVC to the outdoor product.

### CROSS REFERENCE TO RELATED APPLICATION

This application claims the benefit of U.S. Provisional Patent Application No. 63/295,157 filed on Dec. 30, 2021, which is incorporated herein in its entirety.

### FIELD OF INVENTION

The present disclosure relates to weather resistant plastic packaging. More specifically, the present disclosure relates to plastic packaging for outdoor products, such as water hoses and other garden products.

### BACKGROUND

Retailers are known to sell outdoor products, such as garden and gardening products, at outdoor retail locations. Examples of outdoor retail locations include garden centers at big-box retailers and specialty retailers, as well as outdoor markets. Such outdoor retail locations may be covered or partially covered, and may include mesh enclosures. However, such outdoor retail locations are still exposed to weather elements, such as rain, snow, dust, and UV radiation from sunlight.

It is desirable for certain garden products, such as garden hoses, to have packaging that displays information to retail customers. For example, garden hose packaging may include information on hose dimensions and performance specifications. Thus, paper or cardboard packaging is used with garden hoses and other known outdoor products. Such material has long been preferred because it is inexpensive, easy to print on, and easy to cut to size. Paper or cardboard packaging, however, is unable to withstand long exposure to outdoor weather conditions. Specifically, paper and cardboard packaging deteriorates when exposed to water or moisture, and the printing fades after exposure to sunlight.

Because of the shortcomings of paper and cardboard packaging, garden hoses and other such outdoor products are often sold at indoor retail locations, rather than outdoor retail locations. Such arrangements may cause customer frustration and suppress sales. There has therefore been a long felt need for weather resistant packaging for garden hoses and other outdoor products that has gone unmet.

### SUMMARY OF THE INVENTION

In one embodiment, a method of packaging an outdoor product includes providing an outdoor product, and providing a sheet of polyvinyl chloride (“PVC”). The method also includes printing indicia on the sheet of PVC using a UV printing process, cutting the sheet of PVC to a desired shape, and affixing the sheet of PVC to the outdoor product.

In another embodiment, garden hose packaging includes a sheet of PVC having indicia printed thereon. The indicia is printed with an ultra violet printing process, and the sheet of PVC includes a pair of cutouts. The sheet of PVC includes a pair of apertures, including a first aperture and a second aperture. The garden hose packaging further includes a pair of fasteners, including a first fastener and a second fastener.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale, and the proportion of certain elements may be exaggerated for the purpose of illustration.

FIG. 1 is a front plan view of one embodiment of packaging for an outdoor product; and

FIG. 2 is a front view of one embodiment of printed packaging used with a garden hose.

### DETAILED DESCRIPTION

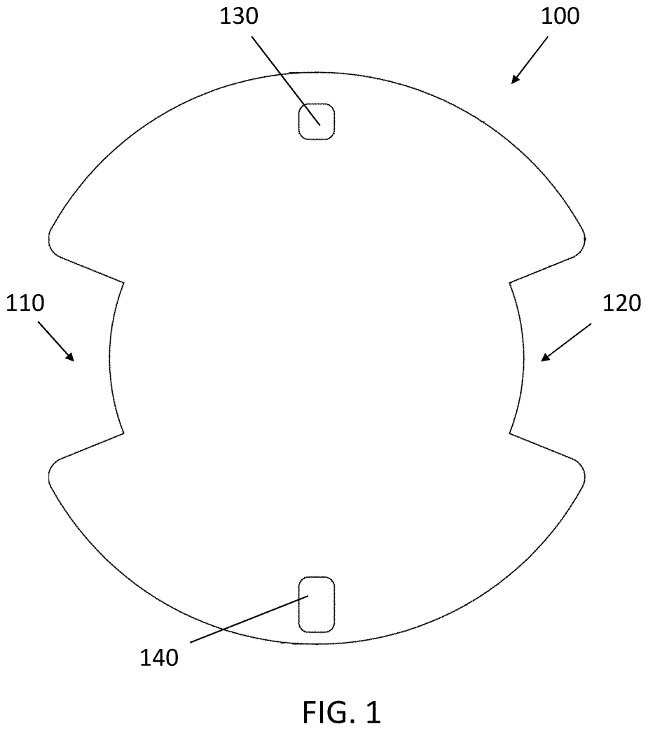

FIG. 1 is a front plan view of one embodiment of packaging 100 for an outdoor product. The packaging is constructed of a polymeric material. In one known embodiment, the packaging 100 is constructed from a sheet of PVC. PVC sheets are resistant to rain, snow, dust, UV radiation, and other weather conditions. In alternative embodiments, the packaging 100 may be constructed of other polymeric material including, without limitation, polypropylene (“PP”), polycarbonate (“PC”), polyethylene (“PE”), or acrylonitrile butadiene styrene (“ABS”) sheets.

In the illustrated embodiment, the packaging 100 is a substantially circular sheet having a first cutout 110 and a second cutout 120. In one embodiment, the circular sheet has a diameter between 25 and 35 cm. In another embodiment, the circular sheet has a diameter between 10 and 50 cm. Additionally, the circular sheet may have a thickness between 0.2 and 0.4 mm. In an alternative embodiment, the circular sheet may have a thickness between 0.1 and 3 mm.

In the illustrated embodiment, the cutouts 110, 120 are contoured to have curved edges. It should be understood, however, that the cutouts may have any shape. Alternatively, the cutouts may be omitted entirely. Additionally, while the packaging 100 is shown as having a substantially circular shape, it should be understood that the packing may be square, rectangular, ovular, or have any geometric shape.

The packaging 100 further includes an upper aperture 130 and a lower aperture 140. In the illustrated embodiment, the upper aperture 130 has a square shape with rounded corners and the lower aperture 140 has a rectangular shape with rounded corners. It should be understood, however, that the apertures may have any shape. In one embodiment, the apertures are sized to receive one or more fasteners, such as a zip tie.

In one embodiment, the packaging 100 is cut from a rectangular sheet of PVC or other plastic. For example, the packaging may be die-cut or laser-cut. In an alternative embodiment, the packaging may be may be made through a molding or 3D printing process.

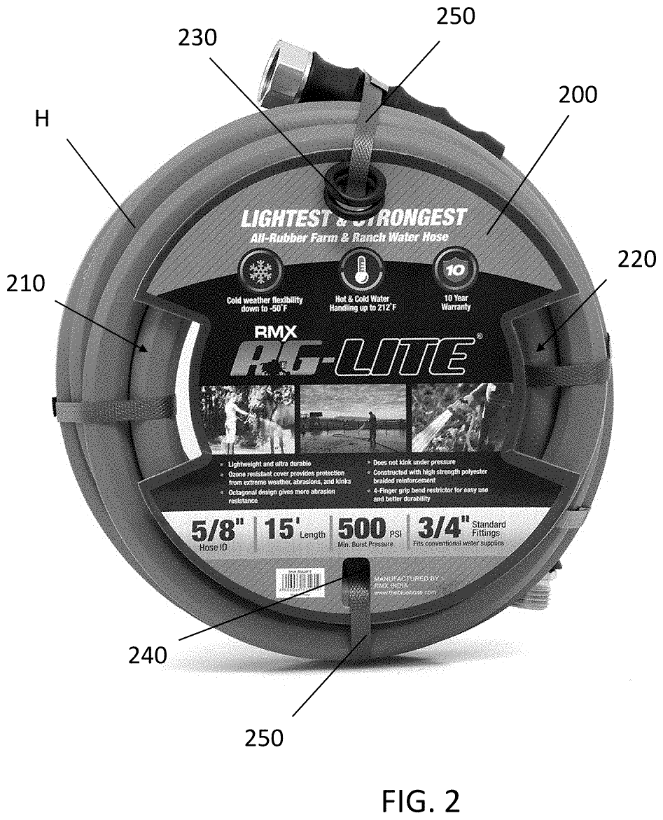

In one embodiment, indicia may be printed directly onto packaging. Indicia may include text, images, or a combination of text and images. FIG. 2 is a front view of one embodiment of printed packaging 200 used with a garden hose H. As can be seen from this view, the packaging 200 is substantially the same as the packaging 100 of FIG. 1, except that it is printed with indicia. It should be understood that any of the alternative embodiments of packaging described above with respect to the packaging 100 of FIG. 1 may apply to the packaging 200 shown here.

The packaging 200 includes first and second cutouts 210, 220 and upper and lower apertures 230, 240. As can be seen from this view, the upper and lower apertures 230, 240 receive zip ties 250. In an alternative embodiment, other fasteners may be employed instead of zip ties.

In one known embodiment, the printed packaging 200 is printed with an ultraviolet printing (“UV printing”) process. UV Printing refers to a printing process that uses ultraviolet curing technology. The UV printing process involves special inks that are formulated to dry quickly when exposed to UV light.

In the UV printing process, as a substrate passes through a printing press and receives wet ink, it is immediately exposed to UV light. Because the UV light quickly dries the application of ink, the ink does not have the opportunity to seep or spread. Indicia such as images and text therefore appear in sharper detail. It has been found that UV-cured ink is less prone to scratches, scuffs, or ink transfer during handling and transportation. It also resists fading, even when exposed to rain, snow, dust, UV radiation, and other weather conditions.

The combination of a plastic sheet with UV-printed indicia has proved to be well-suited for outdoor use. The use of UV-printed, plastic packaging has been surprisingly successful for outdoor products. It has been particularly successful with garden hoses. Such packaging has been found to provide clear text and images to customers, even when exposed to outdoor elements for extended periods of time. This allows customers to easily read the technical specifications for a hose, even when the hose and packaging have been exposed to outdoor weather conditions. Thus, garden hoses with UV-printed, plastic packaging may now be sold at outdoor retail locations, in close proximity to other garden products and outdoor products.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1 A method of packaging an outdoor product, the method comprising:
providing an outdoor product;
providing a sheet of polyvinyl chloride (“PVC”);
printing indicia on the sheet of PVC using a UV printing process;
cutting the sheet of PVC to a desired shape; and
affixing the sheet of PVC to the outdoor product.

2. The method of claim 1, wherein the cutting of the sheet of PVC to the desired shape includes cutting a pair of apertures in the sheet of PVC.

3. The method of claim 2, wherein the affixing of the sheet of PVC to the outdoor product includes passing fasteners through the pair of apertures in the sheet of PVC.

4. The method of claim 2, wherein the cutting of the pair of apertures in the sheet of PVC occurs after the sheet of PVC is cut to the desired shape.

5. The method of claim 1, wherein the cutting of the sheet of PVC to the desired shape includes die-cutting the sheet of PVC to the desired shape.

6. The method of claim 1, wherein the cutting of the sheet of PVC to the desired shape includes laser-cutting the sheet of PVC to the desired shape.

7. The method of claim 1, wherein the UV printing process includes passing the sheet of PVC through a printing press, applying wet ink to the sheet of PVC, and exposing the sheet of PVC to UV light.

8. Garden hose packaging comprising:
a sheet of polyvinyl chloride (“PVC”) having indicia printed thereon,
wherein the indicia is printed with an ultra violet printing process,
wherein the sheet of PVC includes a pair of cutouts, and
wherein the sheet of PVC includes a pair of apertures, including a first aperture and a second aperture; and
a pair of fasteners, including a first fastener and a second fastener.

9. The garden hose packaging of claim 8, wherein the first fastener extends through the first aperture, and wherein the second fastener extends through the second aperture.

10. The garden hose packaging of claim 8, wherein the sheet of PVC sheet has a circular shape with a diameter between 25 and 35 cm.

11. The garden hose packaging of claim 8, wherein the sheet of PVC sheet has a thickness between 0.2 and 0.4 mm.

12. The garden hose packaging of claim 8, further comprising a garden hose.

13. The garden hose packaging of claim 12, wherein each of the pair of fasteners is fastened to the garden hose.

14. The garden hose packaging of claim 8, wherein each of the pair of fasteners is a zip tie.

15. The garden hose packaging of claim 8, wherein each of the pair of apertures has a rectangular shape with rounded corners.

16. A method of packaging a garden hose, the method comprising:
providing a garden hose;
providing a polymeric sheet, wherein the polymeric sheet is made of a material selected from the group consisting of polyvinyl chloride (“PVC”), polypropylene (“PP”), polycarbonate (“PC”), polyethylene (“PE”), and acrylonitrile butadiene styrene (“ABS”). passing the polymeric sheet through a printing press;
applying wet ink to the polymeric sheet;
exposing the polymeric sheet to UV light;
cutting the polymeric sheet to a desired shape;
cutting apertures in the polymeric sheet;
providing fasteners;
passing the fasteners through the apertures; and
fastening the fasteners to the garden hose.

17. The method of claim 16 wherein the cutting of the polymeric sheet to the desired shape occurs at the same time as the cutting of the apertures in the polymeric sheet.

18. The method of claim 16, wherein the cutting of the polymeric sheet to the desired shape occurs before the exposing of the polymeric sheet to UV light.

19. The method of claim 16, wherein the cutting of the polymeric sheet to the desired shape occurs before the passing of the polymeric sheet through a printing press.

20. The method of claim 16, wherein the fasteners are zip ties.
